(19) United States
(12) Patent Application Publication
(10) Pub. No.: US 2008/0192879 A1
(43) Pub. Date: Aug. 14, 2008

(54) REACTOR START-UP MONITORING SYSTEM

(76) Inventors: Yoshihiko Ishii, Hitachinaka (JP); Hitoshi Ochi, Hitachi (JP); Yutaka Iwata, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/018,843

(22) Filed: Jan. 24, 2008

(30) Foreign Application Priority Data
Feb. 8, 2007 (JP) 2007-028886

(51) Int. Cl. G21C 17/00

(52) U.S. Cl. 376/247

(57) ABSTRACT

A reactor start-up monitoring system, comprising:

a determination apparatus for determining that moderator temperature reactivity coefficient is positive based on neutron flux measured by a neutron detector and a reactor water temperature measured by a temperature detection apparatus;

an output information creating apparatus for creating first output information indicating positive moderator temperature reactivity coefficient when determination information inputted from the determination apparatus indicates the positive moderator temperature reactivity coefficient; and

at least one of a display apparatus and an audio output apparatus for inputting the first output information.

### CLAIM OF PRIORITY

The present application claims priority from Japanese application serial no. 2007-028886, filed on Feb. 8, 2007, the content of which is hereby incorporated by reference into this application.

### BACKGROUND OF THE INVENTION

The present invention relates to a reactor start-up monitoring system, and more particularly, to a reactor start-up monitoring system ideally applicable to monitor the start-up of a boiling water reactor having characteristics in that a moderator temperature reactivity coefficient is positive.

In the start-up of a nuclear power plant, for example, a nuclear power plant which uses a boiling water reactor (BWR), reactor power is increased according to the sequential steps of start-up operation; attainment of criticality, attainment of rated pressure, start-up of a electric power generator, and attainment of rated power. Among those steps, the procedure from the beginning of start-up operation to the attainment of criticality is called a “critical mode,” and the procedure from the reactor criticality to the attainment of rated pressure is called a “heat-up mode.” In those procedures, a turbine bypass valve and a turbine control valve are closed, therefore steam is not exhausted from the reactor, and control rods inserted into the reactor core are sequentially withdrawn.

Specifically, at the first-step of the start-up of the sub-critical reactor, control rods are withdrawn sequentially by the operators' manual operation from a core, so as to attain the super-critical condition in which a reactor period (time required for neutron flux φ to become 2.71 times as its original value) is between 100 seconds and 200 seconds. The procedure is called a “critical mode.” After that, the heat-up mode starts in which a reactor pressure is increased up to the rated pressure. The reactor water temperature at the beginning of the heat-up mode is in general approximately 80° C., and the reactor water temperature under the rated pressure is approximately 280° C.

In the beginning of the heat-up mode, the neutron flux increases due to the super-critical condition that means the core has excess positive reactivity, thereby activating the nuclear reaction in the fuel assembly loaded in the core. Generated nuclear heat results in increasing of temperature of reactor water which functions as both neutron moderator and cooling water. In the conventional boiling water reactor, moderator temperature reactivity coefficient is negative. For this reason, as the reactor water temperature increases, negative reactivity is applied to the core, causing the neutron flux increasing rate to decrease. Finally, as the excess reactivity is lost, that is the sub-critical condition, neutron flux and reactor power become decreasing, thereby the neutron flux has maximum value. These effects are enhanced by the Doppler Effect in which negative reactivity is applied by fuel temperature increase.

In a BWR plant which has source range neutron monitors (SRM) and intermediate range monitors (IRM) as neutron detectors, operators perform a switching work of the IRM range as neutron flux increases at the beginning of the heat-up mode. Usually, operation of control rods is not performed until the neutron flux reaches a maximum value. In a BWR plant equipped with start-up range neutron monitors (SRNM) which have the SRM function and the IRM function, it is not necessary to switch the IRM range. Therefore, operators monitor the plant until the neutron flux gets the maximum peak value. Usually, it takes approximately 40 minutes to reach the maximum neutron flux.

After the neutron flux becomes maximum, operators monitor the neutron flux level. When a measured value of the neutron flux has increased up to a certain level, operator compares the measured neutron flux with indication flux level (the value obtained based on the past operation experience so that the temperature change rate of the reactor water becomes almost the target temperature change rate), and when the measured neutron flux will exceed the indication level significantly, operator inserts the control rods into the reactor core. On the contrary, when the measured neutron flux will become less than the indication level, operator withdraws the control rods from the core. During the processes in which control rods are operated, the density of the moderator is decreased by the increase of a reactor water temperature, and the number of neutrons that contribute to nuclear fission is decreased. Therefore, as a whole, as the reactor water temperature increases, the control rods are gradually withdrawn in the heat-up mode.

The reason that the neutron flux gets maximum value is that there is a time lag between the neutron flux and the reactor water temperature. When thermal power of the reactor core increases as the neutron flux increases, the reactor water temperature increases due to reactor core heating. High-temperature reactor water flows from a core exit to an upper plenum, and then ascends in a steam separator and flows out to a downcomer. The high-temperature reactor water flowed out to the downcomer descends in the downcomer, passes through a lower plenum, and then is supplied into the core again. It takes approximately two minutes for circulating reactor water to flow out from an upper end of the core and flow into the core again. During the process, the neutron flux increases, and the level of the neutron flux becomes higher than that in which an equilibrium condition is maintained. Consequently, the neutron flux has a peak maximum value.

Fuel assemblies recently used for boiling water reactors have high burn-up characteristics by increasing uranium enrichment. Economical efficiency of fuel is increased by the high burn-up. For the purpose of efficient burn-up of nuclear fuel, a high burn-up fuel assembly is designed in which the volume of the water area is increased with regard to the volume of the fuel material. In the case in which such fuel assemblies are loaded in the BWR core, it was found that the moderator temperature reactivity coefficient of the core sometimes becomes positive when burn-up progresses and the reactor water temperature is low. As the nuclear fuel burns up, the moderator temperature reactivity coefficient tends to change to a positive value. However, even in this case, when the moderator temperature increases, the moderator temperature reactivity coefficient becomes a negative value.

Because the high burn-up fuel assemblies are designed so that the volume ratio of the water area to fuel area is larger than before, a neutron spectrum is softened (the ratio of thermal neutrons to the entire neutrons is increased). The neutron spectrum is softened even in the case in which nuclear fuel burns up and fissile material is reduced. Furthermore, when compared to the normal operation (approximately 280° C.), water density increases as the reactor water temperature decreases. Consequently, the neutron spectrum at a low temperature is more softened than the rated operation condition.

Generally, a reactor is designed so that the moderator reactivity coefficient is negative. However, in the case in which the neutron spectrum at a low temperature is softened, there is a possibility that the moderator reactivity coefficient becomes positive. In the case in which the moderator temperature reactivity coefficient is positive, the neutron flux increasing rate becomes larger as the reactor water temperature becomes large by the neutron flux increase, because the positive reactivity is induced. As a result, the reactor water temperature change rate becomes larger, too.

A method to control power of the reactor in which the moderator temperature reactivity coefficient is positive is described in Japanese Patent Laid-open No. 2005-241384 and Japanese Patent Laid-open No. 2005-207944. In the power control method described in Japanese Patent Laid-open No. 2005-241384, a reactor water temperature change rate is calculated based on a measured reactor water temperature, and a neutron flux limit value is calculated based on the reactor water temperature change rate at a certain time, the limit value (upper limit value) of the reactor water temperature change rate, and the neutron flux detected at a certain time prior to the above-mentioned time. Then, on the premise that the neutron flux detected at the time mentioned above has exceeded the limit value for the neutron flux, control rods are inserted into the core. The power control method described in Japanese Patent Laid-open No. 2005-241384 is performed during the criticality operation and the heat-up operation. The power control method described in Japanese Patent Laid-open No. 2005-241384 prevents the temperature change rate of the reactor water from increasing too much even when the moderator temperature coefficient is positive.

The method for controlling reactor power described in Japanese Patent Laid-open No. 2005-207944 enables to start up a reactor regardless of whether the moderator temperature reactivity coefficient is positive or negative. According to the power control method, even if the moderator temperature reactivity coefficient is positive, the moderator temperature change rate is maintained within a limit value. In the power control method described in Japanese Patent Laid-open No. 2005-207944, specifically, the neutron flux and the reactor water temperature are measured, and the reactor water temperature change rate is calculated by using the measured reactor water temperature. Then, on the premise that the measured neutron flux is increasing and the reactor water temperature change rate is higher than a certain set value, a control rod is inserted into the core. Japanese Patent Laid-open No. 2005-207944 describes that when control rods are manually operated by the operators guidance is indicated so that operators can insert a control rod at a proper timing.

### SUMMARY OF THE INVENTION

Even in a high burn-up fuel assembly, the moderator temperature reactivity coefficient becomes negative when the reactor water temperature exceeds approximately 150° C., and voids (steam bubbles) are generated in the reactor core and negative void reactivity is induced. Therefore, an increase in neutron flux automatically stops even if the operators leave it as it is. However, until then, the neutron flux and the reactor water temperature increase. When the moderator temperature reactivity coefficient has become positive, it is necessary to insert a control rod into the core to reduce reactivity so that the reactor water temperature change rate will not exceed the limit value of the temperature change rate (for example, 55° C./h). Therefore, unlike the nuclear power plant in which the moderator temperature reactivity coefficient is negative, at the start-up of the nuclear power plant in which the moderator temperature reactivity coefficient is positive, it is necessary to insert a control rod at the beginning of the heat-up mode. It can be predicted to some extent whether the moderator temperature reactivity coefficient of the reactor water is positive or negative by an analysis conducted prior to the start-up of the reactor. However, it cannot be verified until the reactor is actually started up, and there is no means for verifying that the moderator temperature reactivity coefficient has changed to a negative value from a positive value.

With regard to the reactor plants mentioned above, Japanese Patent Laid-open No. 2005-241384 and Japanese Patent Laid-open No. 2005-207944 describe a reactor power control apparatus which estimates whether the moderator temperature reactivity coefficient is positive or negative based on a measured neutron flux and a measured reactor water temperature, and which inserts automatically control rods into the core in the case in which the moderator temperature reactivity coefficient is positive. A latest BWR plant is equipped with a reactor power control apparatus which can automatically insert control rods. But, other old BWR plants do not have such a control apparatus and their operators conduct all of the operation of control rods manually. Introducing the control rod automatic control apparatus, mentioned in the above documents, into such old power plants will require a huge amount of costs. Furthermore, since automatic control has application limitations even in a latest BWR plant, the control rods must be operated manually depending on the characteristics of the core.

Japanese Patent Laid-open No. 2005-207944 describes technology that uses a control rod automatic control function and displays the guidance to indicate a timing at which a control rod is to be inserted when manual operation is conducted by operators. In this case, there is a possibility that the operators may be confused whether to withdraw or insert a control rod because the reason why a control rod must be inserted is not indicated to the operators. Furthermore, when the reactor water temperature rises over a certain temperature, the moderator temperature reactivity coefficient changes from a positive value to a negative value, and it is not necessary to insert a control rod. However, because operators cannot understand the situation, they may end up waiting needlessly for the instruction to insert a control rod that never occurs. Moreover, since it is necessary to insert a control rod more quickly than the withdrawal of a control rod, burden on the operators who stand ready for the insertion of a control rod is not sufficiently reduced.

It is an object of the present invention to provide a reactor start-up monitoring system which can provide appropriate information for the operators when the moderator temperature reactivity coefficient of the reactor water has become positive and can maintain the coolant temperature change rate within a limit value.

To achieve the above mentioned object, the present invention is provided with a determination apparatus for determining that moderator temperature reactivity coefficient is positive based on neutron flux measured by a neutron detector and a reactor water temperature measured by a temperature detection apparatus; an output information creating apparatus for creating first output information indicating positive moderator temperature reactivity coefficient when determination information inputted from the determination apparatus indicates the positive moderator temperature reactivity coefficient; and at least one of a display apparatus and an audio output apparatus that the first output information is inputted.

Because the present invention outputs the first output information indicating that the moderator temperature reactivity coefficient is positive from the determination apparatus to at least one of the display apparatus and the audio output, operators are able to know that the moderator temperature reactivity coefficient has become positive. Therefore, the operators can properly insert control rods into a core, thereby maintaining the coolant temperature change rate within a limit value.

It is preferable that the present invention is provided with a determination apparatus for determining whether the moderator temperature reactivity coefficient is positive or negative based on the neutron flux measured by a neutron detector and a reactor water temperature measured by a temperature detection apparatus; an output information creating apparatus for creating first output information indicating positive moderator temperature reactivity coefficient when determination information inputted from the determination apparatus indicates the positive moderator temperature reactivity coefficient and also creating second output information indicating negative moderator temperature reactivity coefficient when the determination information indicates the negative moderator temperature reactivity coefficient; and at least one of a display apparatus and an audio output apparatus that the first output information and the second output information are inputted.

According to the present invention, when the moderator temperature reactivity coefficient of the reactor core has become positive, it is possible to provide operators with appropriate information, and it is possible to maintain a coolant temperature change rate within a limit value.

### BRIEF DESCRIPTION OF THE DRAWINGS

FIG. 1 is a detail structural diagram showing a reactor start-up monitoring system according to embodiment 1 which is a preferred embodiment of the present invention.

FIG. 2 is a detail structural diagram showing a moderator temperature reactivity determination apparatus shown in FIG. 1.

FIG. 3 is a detail structural diagram showing an output information creating device shown in FIG. 1.

FIG. 4 is a characteristic drawing showing the relationship between the moderator temperature and the moderator temperature reactivity coefficient.

FIG. 5 is a characteristic drawing showing the relationship between the neutron spectrum and the fuel reactivity.

FIG. 6 is a structural diagram showing a reactor start-up monitoring system according to embodiment 2 which is another embodiment of the present invention.

### DETAILED DESCRIPTION OF THE PREFERRED EMBODIMENTS

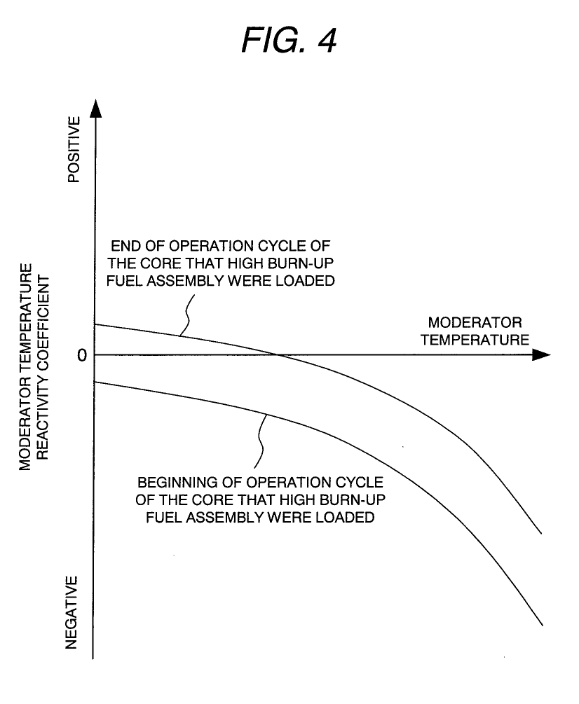

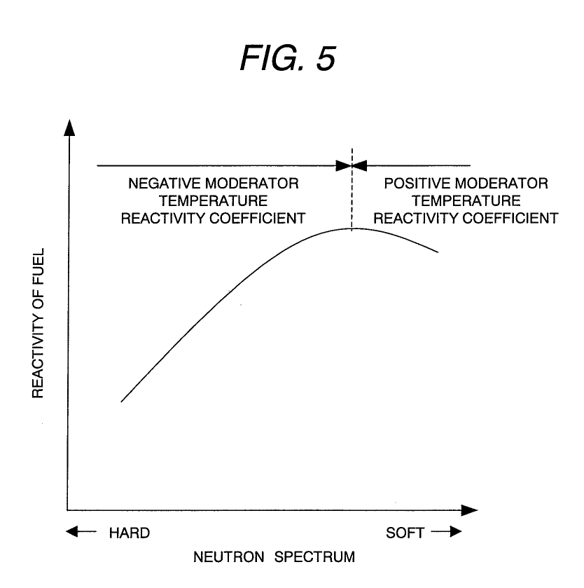

FIG. 4 shows the relationship between the moderator temperature and the moderator temperature reactivity coefficient of a high burn-up fuel assembly loaded in the core. As the moderator temperature increases, the moderator temperature reactivity coefficient tends to become more negative. As nuclear fuel burns up, the moderator temperature reactivity coefficient tends to become positive. FIG. 5 shows the relationship between the neutron spectrum and the fuel reactivity. Fuel assembly is basically designed such that in a range between the cold shutdown temperature and the rated power operation temperature reactivity of fuel increases as the neutron spectrum is softened, that is, moderator temperature reactivity coefficient is negative. This is because when reactor power increases and a reactor water temperature rises, the reactor has self-regulation characteristics of negative reactivity that inhibits an increase of the reactor power. However, it is difficult to design a high burn-up fuel assembly so that the moderator temperature reactivity coefficient becomes always negative under all of the expected conditions. For this reason, when the reactor water temperature is low, there is a possibility that reactivity of the high burn-up fuel assembly decreases when the neutron spectrum becomes soft, that is, the moderator temperature reactivity coefficient is positive, and over-moderating state is formed in the fuel assembly. Even in this case, as a reactor water temperature increases and water density decreases, the neutron spectrum becomes harder and the moderator temperature reactivity coefficient changes to a negative value. The fuel assembly is normally designed such that the moderator temperature reactivity coefficient is negative at temperatures over 150° C.

For the fuel assembly in which the moderator temperature reactivity coefficient of the reactor core is positive, positive reactivity is induced and a neutron flux increasing rate increases when the reactor water temperature increases that is caused by the neutron flux and generated heat increase. As a result, a reactor water temperature change rate increases. Due to the reason mentioned above, an increase in neutron flux automatically stops even if operators leave it as it is. However, until then, the neutron flux and the reactor water temperature increase. For this reason, it is necessary to insert a control rod into the core to reduce reactivity when the moderator temperature reactivity coefficient is positive so that the reactor water temperature change rate will not exceed a limit value of the temperature change rate. If operations of control rods must be switched in the reverse direction because the moderator temperature reactivity coefficient has changed from a negative value to a positive value (or reverse), it is necessary to inform the operators about this change as quickly and accurately as possible. It can be predicted to some extent whether the moderator temperature reactivity coefficient of the reactor water is positive or negative by analyses conducted prior to the start-up of the reactor. However, it cannot be verified until the reactor actually starts up, and there is no means for verifying that the moderator temperature reactivity coefficient has changed to a negative value from a positive value.

The present invention is realized to satisfy such a demand.

Hereafter, embodiments of the present invention will be explained with reference to the drawings.

### Embodiment 1

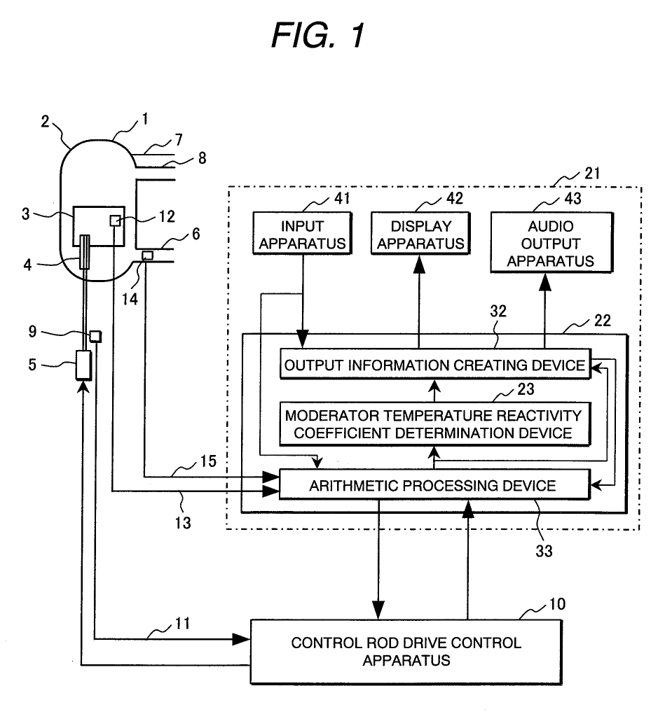

A reactor start-up monitoring system according to embodiment 1 which is a preferred embodiment of the present invention will be described by referring to FIGS. 1 through 3. A reactor start-up monitoring system of the present embodiment is an example that is applied to a boiling water reactor.

A boiling water reactor 1 is equipped with a reactor pressure vessel 2 in which a core 3 loaded with a plurality of fuel assemblies (not shown) is included. Those fuel assemblies are high burn-up fuel assemblies. A plurality of neutron detectors 12 are disposed among fuel assemblies in the core 3. A plurality of control rods 4 to be inserted among the fuel assemblies in the core 3 are disposed. A plurality of control rod drives 5 are individually connected to each control rod 4. Each control rod drive 5 inserts a control rod 4 into the core 3 and withdraws the control rod 4 from the reactor core 3. The control rod drive 5 is a hydraulically-driven control rod drive. As a control rod drive 5, it is possible to use an electrically-driven control rod drive that uses a step motor (or induction motor) . By withdrawing or inserting the control rod 4, nuclear fission reaction of fuel material in a plurality of fuel rods (not shown) of a fuel assembly is controlled, thereby the reactor power is regulated. Each control rod drive 5 is controlled by a control rod drive control apparatus 10. A control rod position detector 9 is attached to each control rod drive 5. Signals of the control rod position detectors 9 are connected to the control rod drive control apparatus 10.

Overview of the operation of the reactor 1 with the rated power will be described below. Cooling water in the reactor pressure vessel 2 flows out into a recirculation pipe 6 and is pressurized by a recirculation pump (not shown) disposed in the recirculation pipe 6. The pressurized cooling water is directed through the recirculation pipe 6 to nozzles of jet pumps (not shown) located between the reactor pressure vessel 2 and the reactor core 3 and ejected from the nozzles. The ejected jet flow leads cooling water existing around the nozzle to the jet pump. Cooling water discharged from the jet pump outlet is supplied to the core 3 through a lower plenum located below the core 3. Cooling water that ascends in the core 3 is heated as the result of the above-mentioned nuclear fission reaction, and a part of the cooling water changes into steam. The steam is separated from the cooling water by a steam separator (not shown) disposed above the core 3 and a steam dryer (not shown), subsequently introduced to a turbine (not shown) through a main steam pipe 7. The steam rotates the steam turbine blades. The steam discharged from the steam turbine is condensed by a condenser (not shown) and turns into water. The water is supplied as feed water to the reactor pressure vessel 2 through a feed water pipe 8.

A control rod drive control apparatus 10 gives a command to the corresponding control rod drive(s) 5 so as to perform the operation (withdrawal or insertion) of the control rod(s) 4 connected to that control rod drive(s) 5. Information about the amount of insertion of the control rod 4 (information about a position in the axial direction of the reactor core 3) is detected by the control rod position detector 9 and conveyed to the control rod drive control apparatus 10. The control rod drive control apparatus 10 can confirm whether the control rod 4 is operated as instructed based on this information.

A reactor start-up monitoring system 21 according to this embodiment is provided with a reactor start-up monitoring apparatus 22, an input apparatus 41, a display apparatus 42 and an audio output apparatus 43. The reactor start-up monitoring apparatus 22 has a arithmetic processing device 33, a moderator temperature reactivity coefficient determination device 23 and an output information creating device 32. The arithmetic processing device 33 is connected to each neutron detector 12, a temperature detector 14 disposed in the recirculation pipe 6 and the control rod drive apparatus 10. The temperature detector 14 measures the temperature of cooling water that flows into the recirculation pipe 6. The arithmetic processing device 33 is connected to the moderator temperature reactivity coefficient determination device 23 and the output information creating device 32. The moderator temperature reactivity coefficient determination device 23 is connected to the output information creating device 32.

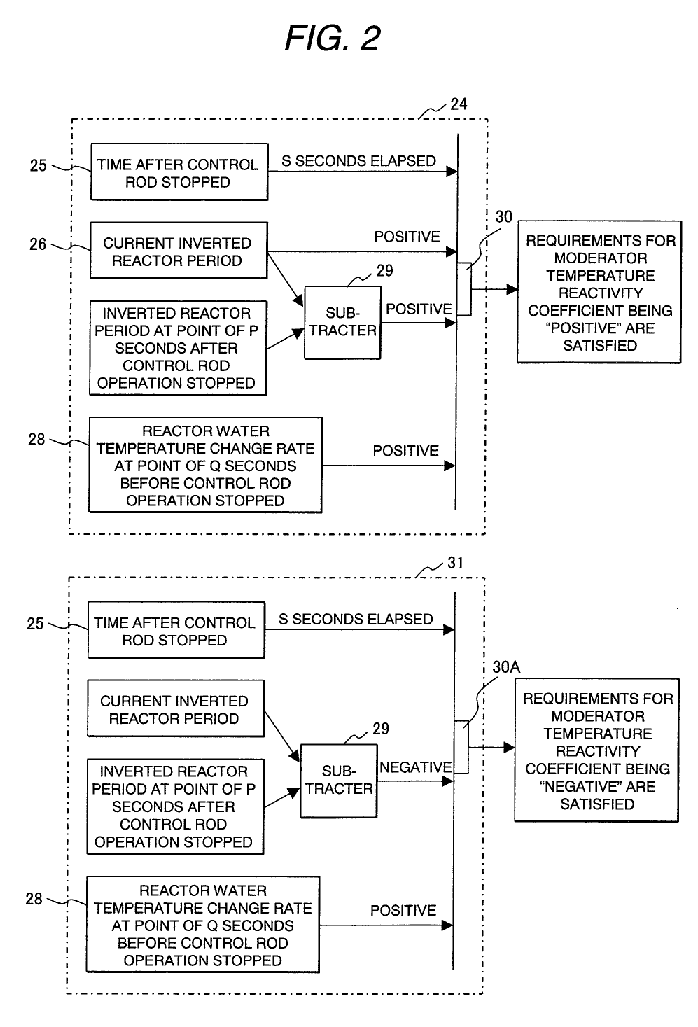

As shown in FIG. 2, the moderator temperature reactivity coefficient determination device 23 is equipped with moderator temperature reactivity coefficient determination elements 24 and 31. The moderator temperature reactivity coefficient determination element 24 determines whether the moderator temperature reactivity coefficient is positive, and the moderator temperature reactivity coefficient determination element 31 determines whether the moderator temperature reactivity coefficient is negative. The moderator temperature reactivity coefficient determination element 24 has a control rod halt elapsed time measurement section 25, an inverted reactor period determination section 26, a reactor water temperature change rate calculation section 28, a subtracter 29 and an AND circuit 30. The inverted reactor period determination section 26 is connected to the subtracter 29. The control rod halt elapsed time measurement section 25, inverted reactor period determination section 26, reactor water temperature change rate calculation section 28 and the subtracter 29 are connected to the AND circuit 30. The control rod halt elapsed time measurement section 25, inverted reactor period determination section 26, reactor water temperature change rate calculation section 28 and the subtracter 29 are connected to the arithmetic processing device 33.

The moderator temperature reactivity coefficient determination element 31 comprises a control rod halt elapsed time measurement section 25, a reactor water temperature change rate calculation section 28, a subtracter 29 and an AND circuit 30A. The control rod halt elapsed time measurement section 25, reactor water temperature change rate calculation section 28 and the subtracter 29 are connected to the AND circuit 30A. Except that the inverted reactor period determination section 26 is not connected to the AND circuit 30A, the moderator temperature reactivity coefficient determination element 31 has the same configuration as that of the moderator temperature reactivity coefficient determination element 24. The control rod halt elapsed time measurement section 25 of the moderator temperature reactivity coefficient determination element 31, reactor water temperature change rate calculation section 28 and the subtracter 29 are connected to the arithmetic processing device 33.

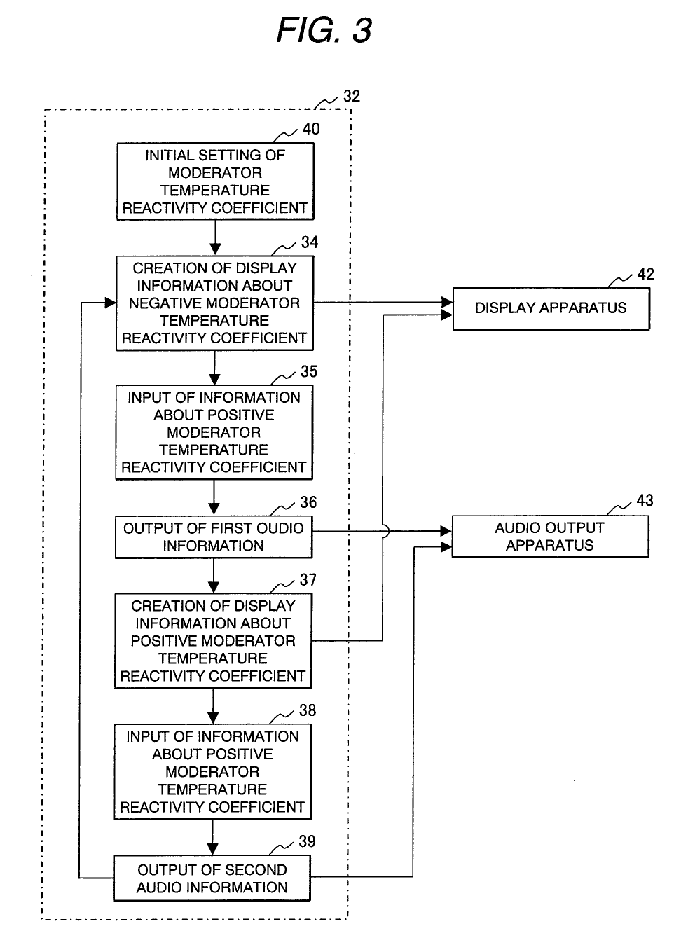

The output information creating device 32 is connected to the AND circuits 30, 30A, input apparatus 41, display apparatus 42 and the audio output apparatus 43 individually. The input apparatus 41 is also connected to the arithmetic processing device 33. The output information creating device 32 repeatedly executes the processing from steps 34 to 39, shown in FIG. 3, based on the information outputted by the AND circuits 30, 30A and creates display information about the moderator temperature reactivity coefficient.

An input apparatus 41 of the reactor start-up monitoring system 21 is equipped with switches (including the withdrawal start switch and the insertion start switch), a keyboard and a computer touch panel located on the control panel respectively. When an operator who sits at the control panel withdraws an appropriate control rod 4, the operator selects the corresponding control rod 4 based on the information indicating the sequential order of the control rod operation displayed on the display apparatus 42 and presses the withdrawal start switch (not shown). By doing so, the corresponding control rod 4 starts to be withdrawn from the reactor core 3. While monitoring the information such as the neutron flux level displayed on the display apparatus 42, the operator presses the withdrawal start switch at the appropriate timing to operate the control rod 4.

At the start-up of the reactor 1 mentioned above, the reactor start-up monitoring apparatus 22 has a role for intermediating between the operator's control rod operation and the control rod drive control apparatus 10. That is, a storage device (not shown) of the control rod drive control apparatus 10 stores sequence information about the control rod operations (which prescribes sequential order of control rods 4 to be withdrawn from the core 3 and the amount of withdrawal) in the start-up procedure from the subcritical condition to the rated power operation. The control rod drive control apparatus 10 gets the sequence information from the storage device and outputs the information to the arithmetic processing device 33 of the reactor start-up monitoring apparatus 22. The sequence information is inputted to the output information creating device 32 and displayed on the display apparatus 42. Specifically, the control rod drive control apparatus 10 outputs the following information to the arithmetic processing device 33 of the reactor start-up monitoring apparatus 22: information about the position of the radial direction in the core 3 of the control rod 4 to be withdrawn from now, information about the amount of withdrawal in the axial direction in the core 3 for the control rod 4 to be withdrawn from now, information about the radial position in the core 3 of the control rod 4 to be withdrawn next, and information about the amount of withdrawal in the axial direction of the core 3 for the control rod 4 to be withdrawn next. Those four pieces of information are displayed on the display apparatus 42. At that time, a withdrawal indicator lamp of the corresponding control rod 4 on the display apparatus 22 lights up. Related information, such as information about the position of the control rod 4 to be withdrawn, which has been entered by the input apparatus 41 is inputted into the control rod drive control apparatus 10 via the arithmetic processing device 33 as stated above.

At the start-up of the reactor 1, control rods 4 are withdrawn from the core 3 to achieve the critical state from the sub-critical condition, and after that other control rods 4 are withdrawn to increase reactor power and finally through the heat-up mode rated power condition is achieved. These sequential control rod operations at the start-up of the reactor 1 are executed manually according to the sequence information. That is, based on the control rod operation sequence information displayed on the display apparatus 42, an operator sequentially inputs the information about the radial position and amount of withdrawal of the control rod 4 to be withdrawn into the arithmetic processing device 33 by using the input apparatus 41. Based on the information entered by the arithmetic processing device 33, the control rod drive control apparatus 10 outputs a control rod withdrawal command to the control rod drive 5 connected to the corresponding control rod 4. The control rod drive 5 withdraws only the corresponding control rod 4 from the reactor core 3 by the corresponding amount of withdrawal. Control rods 4 indicated by the input apparatus 41 are sequentially withdrawn. The following control rod 4 cannot be operated until operation of the current control rod 4 has been done.

As the result of withdrawal of control rods 4 by an operator based on the control rod operation sequence information as mentioned above, the state of the core 3 changes from the sub-critical condition to the critical one, and the neutron flux is increased in the core 3, thereby increasing the cooling water temperature in the reactor pressure vessel 2. The cooling water temperature is raised to the rated temperature (for example, approximately 280° C.), and then the reactor power is increased to the rated power.

Time-series information about each neutron flux signal 13 measured and outputted by each neutron detector 12 and time-series information about the cooling water temperature signal 15 measured and outputted by the temperature detector 14 are individually inputted into the arithmetic processing device 33 of the reactor start-up monitoring apparatus 22. Since the temperature in the boiling water reactor core is usually not measured directly, in the present embodiment, the temperature of cooling water flowing through the recirculation pipe 6 measured by a temperature detector 14 is used as a cooling water temperature in the core 3 (hereafter, referred to as core cooling water temperature).

At the start-up of the reactor 1, the arithmetic processing device 33 of the reactor start-up monitoring apparatus 22 calculates a reactor period based on the inputted time-series information about the neutron flux signal 13, and then calculates an inverted reactor period by using the obtained reactor period. The arithmetic processing device 33 calculates a reactor water temperature change rate by using the time-series information about the reactor core cooling water temperature signal 15. Moreover, when a control rod operation is finished, the control rod drive control apparatus 10 outputs a control rod operation end signal of each control rod 4 that has been operated (for example, withdrawal operation of control rod 4) to the arithmetic processing device 33. The control rod operation end signal is outputted from the control rod drive controller 10 when the control rod position detected by the control rod position detector 9 has reached the set position at which the control rod should be located when the operation has ended (for example, set according to information about the amount of withdrawal). Using a timer the arithmetic processing device 33 measures an elapsed time after the control rod operation end signal was inputted, that is, the elapsed time from the time at which the control rod operation stopped. The arithmetic processing device 33 stores the calculated inverted reactor period and the reactor water temperature change rate together with the time information provided by the above timer in the storage device (not shown) of the reactor start-up monitoring apparatus 22. The arithmetic processing device 33 outputs the obtained reactor period and the reactor water temperature change rate, the inputted neutron flux signal 13 and the cooling water temperature signal 15 to the output information creating device 32. As requested by an operator via the input apparatus 41, the output information creating device 32 outputs information about the neutron flux level, reactor period, reactor water temperature and the reactor water temperature change rate to the display apparatus 42 to be displayed thereon.

A reactor period is an index that shows a neutron flux increasing rate, and as the reactor period is short, the neutron flux increasing rate is large. The reactor period can be calculated by using a neutron flux signal 13. A reactor period can be calculated by the method, for example, described in Japanese Patent Laid-open No. 2005-241384. The present embodiment uses an inverted reactor period that has been thus calculated. The larger the inverted reactor period is, the larger the neutron flux increasing rate is, and when the inverted reactor period is negative, it means that the neutron flux is decreasing. Accordingly, the inverted reactor period is an index that can continuously indicate neutron flux change rates.

The arithmetic processing device 33 outputs the following information to the moderator temperature reactivity coefficient determination elements 24, 31 of the moderator reactivity determination device 23; information about the elapsed time after the control rod operation stopped, an current inverted reactor period that is the inverted reactor period at the time at which the moderator reactivity determination device 23 executes determination, an inverted reactor period at the time that p seconds has passed after the control rod operation stopped, and a reactor water temperature change rate at a time point of q seconds before the control rod operation stopped that have been retrieved from the storage device. A previous value is set for the inverted reactor period when p seconds have not yet passed after the control rod operation executed. When control rods are manually operated based on the control rod operation sequence information to make critical from sub-critical condition, and the temperature of the cooling water (moderator) in the reactor pressure vessel 2 increases, it comes to be able to determine for the moderator reactivity determination device 23 whether the moderator temperature reactivity coefficient is positive or negative by moderator temperature reactivity coefficient determination elements 24, 31.

Each control rod halt elapsed time measurement section 25 of the moderator temperature reactivity coefficient determination elements 24, 31 inputs information about the elapsed time after the control rod operation stopped and outputs “1” when the elapsed time became S seconds (S>p) after the control rod operation stopped. Before S seconds have passed, “0” is outputted from each control rod halt elapsed time measurement section 25. The inverted reactor period determination section 26 of the moderator temperature reactivity coefficient determination element 24 determines whether the inverted reactor period is “positive” or “negative” based on the inputted current inverted reactor period. The inverted reactor period determination section 26 outputs “1” when the inverted reactor period is “positive,” and outputs “0” when it is “negative.” Each subtracter 29 of the moderator temperature reactivity coefficient determination elements 24, 31 inputs a current inverted reactor period (hereafter, referred to as “first inverted reactor period”) and an inverted reactor period at the time that p seconds has passed after the control rod operation stopped (hereafter, referred to as “second inverted reactor period”) and subtracts the second inverted reactor period from the first inverted reactor period. The subtracter 29 of the moderator temperature reactivity coefficient determination element 24 outputs “1” when an obtained value is “positive” and outputs “0” when the obtained value is “negative.” When this subtracter 29 outputs “1,” a neutron flux increasing rate is increasing in the reactor core 3. The subtracter 29 of the moderator temperature reactivity coefficient determination element 31 outputs “1” when an obtained value is “negative” and outputs “0” when the obtained value is “positive.” When this subtracter 29 outputs “1,” a neutron flux increasing rate is decreasing in the reactor core 3. Each reactor water temperature change rate calculation section 28 of the moderator temperature reactivity coefficient determination elements 24, 31 outputs “1” when a reactor water temperature change rate at a time point of q seconds before the control rod operation stopped is “positive” and outputs “0” when the change rate is “negative.”

When “1” (S seconds elapsed) is inputted from the control rod halt elapsed time measurement section 25, “1” (“positive”) is inputted from the inverted reactor period determination section 26, “1” (“positive”) is inputted from the reactor water temperature change rate calculation section 28, and “1” (“positive”) is inputted from the subtracter 29, the AND circuit 30 of the moderator temperature reactivity coefficient determination element 24 outputs “1” which means “the positive moderator temperature reactivity coefficient” indicating that requirements for the moderator temperature reactivity coefficient being “positive” was satisfied. When “1” (S seconds elapsed) is inputted from the control rod halt elapsed time measurement section 25, “1” (“positive”) is inputted from the reactor water temperature change rate calculation section 28, and “1” (“negative”) is inputted from the subtracter 29, the AND circuit 30A of the moderator temperature reactivity coefficient determination element 31 outputs “1” which means “the negative moderator temperature reactivity coefficient” indicating that requirements for the moderator temperature reactivity coefficient being “negative” was satisfied.

The above-mentioned S seconds and p seconds are set so as to eliminate influences of transient response that occurs right after the control rod operation stopped. For example, a set value for S seconds is 120 seconds, and a set value for p seconds is 60 seconds. The q seconds compensates time lag between a measured reactor water temperature and a measured neutron flux in the core 3, and a set value of q seconds is, for example, 120 seconds. At the beginning of the heat-up mode in which the moderator temperature reactivity coefficient turns into problem, time intervals between each control rod operation according to control rod operation sequence information are usually two minutes or more, therefore, the above set value is appropriate. In the embodiments of the present invention each value of S seconds, p seconds and q seconds used for the moderator temperature reactivity coefficient determination element 31 is the same as each value used for the moderator temperature reactivity coefficient determination element 24; however, different values can be used.

Furthermore, configuration of the moderator temperature reactivity coefficient determination elements 24, 31 can be different from the configuration shown in FIG. 2. For example, to use program functions of the moderator temperature reactivity coefficient determination elements 24, 31 is possible. It is possible for the moderator reactivity determination device 23 to determine the moderator temperature reactivity coefficient by replacing the moderator temperature reactivity coefficient determination elements 24, 31 to the software program.

As stated above, the present embodiment evaluates the neutron flux increasing rate by using the inverted reactor period as an index; however, a reactor period can be used as the index for the evaluation. Furthermore, it is possible to evaluate the neutron flux increasing rate by using neutron fluxes.

The moderator reactivity determination device 23 transfers data from AND circuits 30, 30A to the output information creating device 32. However, the AND circuit 30 and the AND circuit 30A do not simultaneously output information of “the positive moderator temperature reactivity coefficient” and “the negative moderator temperature reactivity coefficient”. Creation of output information by the output information creating device 32 will be specifically described according to the procedure from steps 34 to 40 shown in FIG. 3. A flag indicating whether the moderator temperature reactivity coefficient is initially set to “negative” (step 40). Accordingly, the output information creating device 32 creates display information of “the negative moderator temperature reactivity coefficient” (step 34) and outputs this display information to the display apparatus 42. The display apparatus 42 displays the information of “the negative moderator temperature reactivity coefficient”. When information of “the positive moderator temperature reactivity coefficient” is inputted from the AND circuit 30 (step 35), first audio information, for example, audio information indicating “the moderator temperature reactivity coefficient is positive. Insertion operation of control rods is necessary” is outputted to an audio output apparatus (for example, speaker) 43 (step 36). Display information of “the positive moderator temperature reactivity coefficient” is created (step 37). This display information is outputted to the display apparatus 42 and displayed thereon. This display information can be a text showing the above-mentioned first audio information. When information of “the negative moderator temperature reactivity coefficient” is inputted from the AND circuit 30A (step 38), second audio information, for example, audio information indicating “the moderator temperature reactivity coefficient is now negative. Withdrawal operation of control rods can be started.” is outputted to the audio output apparatus 43 (step 39). Display information of “the negative moderator temperature reactivity coefficient” is created (step 34). This display information is outputted to the display apparatus 42 and displayed thereon. Display information created in step 34 can be a text showing the above-mentioned second audio information. Operators are able to see whether the moderator temperature reactivity coefficient is positive or negative by looking at the display apparatus 42. Since the first and second audio informations are outputted by the audio output apparatus 43, it is possible to alert operators by sound. At the start-up of the reactor, when information of “the positive moderator temperature reactivity coefficient” is inputted, the output information creating device 32 executes the operations of steps 36 and 37, and when information of “the negative moderator temperature reactivity coefficient” is inputted, the output information creating device 32 executes the operations of steps 39 and 34.

The information outputted from the moderator temperature reactivity determination device 23, that is, the information outputted from AND circuit 30, 30A, is inputted into a control rod drive control apparatus 10 via an arithmetic processing device 33. When receiving information of “the positive moderator temperature reactivity coefficient” from the reactor start-up monitoring apparatus 22, the control rod drive control apparatus 10 outputs information about the position of the control rod 4 to be inserted in the radial direction of the core 3 and information about the amount of insertion to a reactor start-up monitoring apparatus 22, specifically to an arithmetic processing device 33. Those pieces of information are outputted to the display apparatus 42 via an output information creating device 32 and displayed thereon. Furthermore, an insertion operation indicator lamp is lit. In the case in which an operator performs the insertion operation of the control rod 4 indicated on the display apparatus 42 to be inserted, the operator presses the above-mentioned insertion start switch (not shown). By doing so, the prescribed control rod 4 is inserted into the core 3. While monitoring information about a neutron flux level, reactor period and a reactor water temperature change rate displayed on the display apparatus 42, an operator presses the insertion start switch at a timing the operator considers appropriate.

When the moderator temperature reactivity coefficient becomes negative as a result of the insertion operation of the control rod 4, the control rod drive control apparatus 10 inputs information about “the negative moderator temperature reactivity coefficient” from the reactor start-up monitoring apparatus 22. The control rod drive control apparatus 10 retrieves, from a storage device, information about the radial position in the reactor core 3 of the control rod 4 to be withdrawn next and information about the amount of withdrawn, and outputs these pieces of information to the arithmetic processing device 33. Those pieces of information are displayed on the display apparatus 42. Based on the information, operators withdraw the corresponding control rod 4 as mentioned above.

In the present embodiment, the moderator temperature reactivity determination device 23 determines whether the moderator temperature reactivity coefficient is positive or negative at the start-up process of the reactor 1, specifically, in the process in which criticality is achieved from a sub-critical condition and in the heat-up mode. According to the determination results, either information of “the positive moderator temperature reactivity coefficient” or information of “the negative moderator temperature reactivity coefficient” is announced to operators by a display apparatus 42 and an audio output apparatus 43. Therefore, when the moderator temperature reactivity coefficient has changed from a negative value to a positive value, it is possible for the operators to accurately know the change. When the moderator temperature reactivity coefficient has become positive, operators can manually insert a control rod 4 into the core 3 accurately and reliably. Since the insertion operation will reduce a reactor water temperature change rate, it is possible to prevent the reactor water temperature change rate from exceeding a limit value at the start-up process of the reactor 1 such as in the heat-up mode.

When receiving information of “the positive moderator temperature reactivity coefficient” from the moderator reactivity determination device 23, the control rod drive control apparatus 10 outputs information about the radial position in the core 3 of the control rod 4 to be inserted next and information about the amount of insertion to the reactor start-up monitoring apparatus 22. The reactor start-up monitoring apparatus 22 displays those pieces of information on the display apparatus 42. Therefore, operators can know that a control rod 4 should be inserted as well as which control rod 4 is to be inserted and the amount of insertion. As a result, when the moderator temperature reactivity coefficient has become positive, it is possible for the operators to insert an appropriate control rod 4 into the core 3 by a necessary amount of insertion.

When the moderator temperature reactivity coefficient changed negative from positive value, operators can also know the change accurately. When the moderator temperature reactivity coefficient became negative, it is possible for the operators to withdraw a control rod 4 without error. At that time, the reactor start-up monitoring apparatus 22 inputs information about the radial position in the core 3 of the control rod 4 to be withdrawn next and information about the amount of withdrawal from the control rod drive control apparatus 10 and displays these pieces of information on the display apparatus 42. By looking at the information displayed on the display apparatus 42, the operators can withdraw the prescribed control rod 4 manually by the necessary amount of withdrawal when the moderator temperature reactivity coefficient has become negative.

When the moderator temperature reactivity coefficient has become positive, the present embodiment displays the information on the display apparatus 42 and also announces the information by sound via an audio output apparatus 43. Therefore, operators can surely know that the moderator temperature reactivity coefficient is positive. When the moderator temperature reactivity coefficient has become negative, the information indicating that the moderator temperature reactivity coefficient has become negative is announced to the operators by means of a display apparatus 42 and an audio output apparatus 43, the operators can surely know the situation.

The present embodiment can provide operators with appropriate information with regard to the moderator temperature reactivity coefficient. Therefore, it is possible to reduce burden onto the operators when monitoring the nuclear power plant.

The present embodiment uses moderator temperature reactivity coefficient determination elements 24, 31 each of which has simple logic configuration. Therefore, configuration of the reactor start-up monitoring apparatus 22 can be simplified. Since configuration of the present embodiment is simple, the present embodiment can be easily applied to the existing nuclear power plants as well as new nuclear power plants.

It is also possible to use either a display apparatus 42 or an audio output apparatus 43.

### Embodiment 2

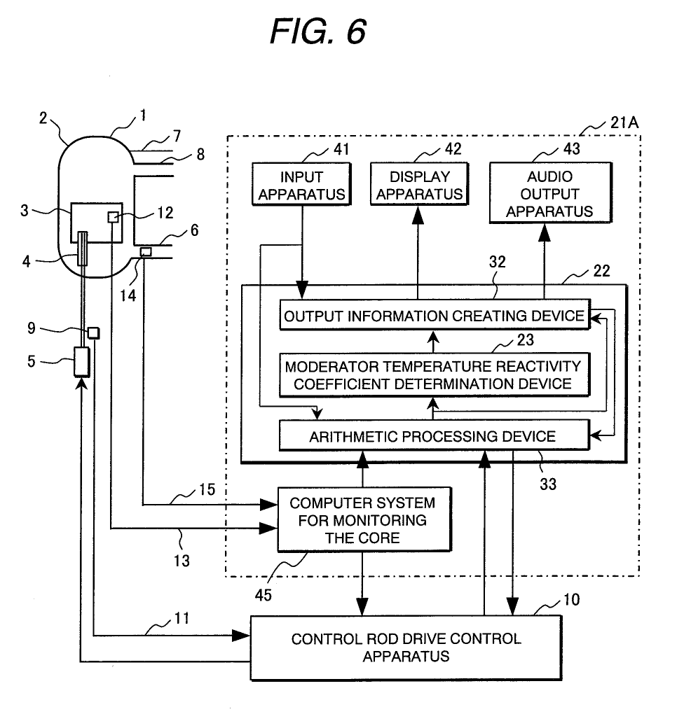

A reactor start-up monitoring system according to embodiment 2 that is another embodiment of the present invention will be described with reference to FIG. 6. A reactor start-up monitoring system 21A according to the present embodiment has construction in which a computer system 45 to monitor the reactor core is added to the reactor start-up monitoring system 21 according to embodiment 1. The computer system 45 is connected to a neutron detector 12, a temperature detector 14, an arithmetic processing device 33 and a control rod drive control apparatus 10 individually. The computer system 45 inputs a neutron flux signal 13 outputted from each neutron detector 12 and a cooling water temperature signal 15 outputted from a temperature detector 14. The computer system 45 calculates a reactor period and a reactor water temperature change rate based on those pieces of information. Moreover, the computer system 45 obtains an inverted reactor period based on the calculated reactor period. The inverted reactor period and the reactor water temperature change rate that have been calculated are inputted into an arithmetic processing device 33 from the computer system 45. The computer system 45 calculates the inverted reactor period and the reactor water temperature change rate that were calculated by the arithmetic processing device 33 in embodiment 1. In other words, a reactor start-up monitoring apparatus 22 in the present embodiment is different from a reactor start-up monitoring apparatus 22 in embodiment 1 with regard to one point wherein the reactor start-up monitoring apparatus 22 in the present embodiment does not calculate an inverted reactor period and a reactor water temperature change rate.

By inputting an inverted reactor period and a reactor water temperature change rate, a reactor start-up monitoring apparatus 22 in the present embodiment functions in the same manner as a reactor start-up monitoring apparatus 21 in embodiment 1 and determines the moderator temperature reactivity coefficient. In the present embodiment as well, information of “the positive moderator temperature reactivity coefficient” or information of “the negative moderator temperature reactivity coefficient” is outputted from the reactor start-up monitoring apparatus 22 and displayed on the display apparatus 42. Moreover, first audio information or second audio information is outputted from an audio output apparatus 43.

The present embodiment also ensures the same effects as are obtained by embodiment 1. A computer system 45 is installed in existing boiling water reactors, and a neutron flux signal 13 and a cooling water temperature signal 15 are entered thereby calculating a reactor period and a reactor water temperature change rate. Since the present embodiment uses the computer system 45, system configuration of the reactor start-up monitoring apparatus 22 in the present embodiment can be simpler than the configuration of the reactor start-up monitoring apparatus 22 in embodiment 1.

What is claimed is:

1. A reactor start-up monitoring system, comprising:
a determination apparatus for determining that moderator temperature reactivity coefficient is positive based on neutron flux measured by a neutron detector and a reactor water temperature measured by a temperature detection apparatus;
an output information creating apparatus for creating first output information indicating positive moderator temperature reactivity coefficient when determination information inputted from said determination apparatus indicates said positive moderator temperature reactivity coefficient; and
at least one of a display apparatus and an audio output apparatus for inputting said first output information.

2. The reactor start-up monitoring system according to claim 1,
wherein said first output information includes information about insertion of a control rod.

3. The reactor start-up monitoring system according to claim 1,
wherein when set time has elapsed after a control rod operation stopped, said determination apparatus determines that said moderator temperature reactivity coefficient is positive, based on either a reactor period or an inverted reactor period calculated by using the neutron flux and a reactor water temperature change rate calculated by using said reactor water temperature.

4. The reactor start-up monitoring system according to claim 1,
wherein when first set time has elapsed after a control rod operation stopped, said determination apparatus determines that said moderator temperature reactivity coefficient is positive, based on either a first reactor period or a first inverted reactor period calculated by using the neutron flux, a reactor water temperature change rate calculated by using said reactor water temperature, and either a first positive value obtained by subtracting a first reactor period from a second reactor period herein said second reactor period is a reactor period when second set time, shorter than said first set time, has elapsed after said control rod operation, or a second positive value obtained by subtracting a second inverted reactor period from said first inverted reactor period herein said second inverted reactor period is a inverted reactor period when said second set time has elapsed.

5. A reactor start-up monitoring system comprising
a determination apparatus for determining whether moderator temperature reactivity coefficient is positive or negative based on the neutron flux measured by a neutron detector and a reactor water temperature measured by a temperature detection apparatus;
an output information creating apparatus for creating first output information indicating positive moderator temperature reactivity coefficient when determination information inputted from said determination apparatus indicates said positive moderator temperature reactivity coefficient and also creating second output information indicating negative moderator temperature reactivity coefficient when said determination information indicates said negative moderator temperature reactivity coefficient; and
at least one of a display apparatus and an audio output apparatus for inputting said first output information and said second output information.

6. The reactor start-up monitoring system according to claim 5,
wherein said first output information includes information about insertion of a control rod.

7. The reactor start-up monitoring system according to claim 5,
wherein said second output information includes information about withdrawal of a control rod.

8. The reactor start-up monitoring system according to claim 5,
wherein when set time has elapsed after a control rod operation stopped, said determination apparatus determines that said moderator temperature reactivity coefficient is positive, based on either a reactor period or an inverted reactor period calculated by using the neutron flux and a reactor water temperature change rate calculated by using said reactor water temperature.

9. The reactor start-up monitoring system according to claim 5,
wherein when set time has elapsed after a control rod operation stopped, said determination apparatus determines that the moderator temperature reactivity coefficient is negative, based on either a reactor period or an inverted reactor period calculated by using the neutron flux and a reactor water temperature change rate calculated by using said reactor water temperature.

10. The reactor start-up monitoring system according to claim 5,
wherein when first set time has elapsed after a control rod operation stopped, said determination apparatus determines that said moderator temperature reactivity coefficient is positive, based on either a first reactor period or a first inverted reactor period calculated by using the neutron flux, a reactor water temperature change rate calculated by using said reactor water temperature, and either a first positive value obtained by subtracting a first reactor period from a second reactor period herein said second reactor period is a reactor period when second set time, shorter than said first set time, has elapsed after said control rod operation stopped, or a second positive value obtained by subtracting a second inverted reactor period from said first inverted reactor period herein said second inverted reactor period is a inverted reactor period when said second set time has elapsed.

11. The reactor start-up monitoring system according to claim 5,
wherein when first set time has elapsed after a control rod operation stopped, said determination apparatus determines that the moderator temperature reactivity coefficient is negative, based on either a first reactor period or a first inverted reactor period calculated by using the neutron flux, a reactor water temperature change rate calculated by using said reactor water temperature, and either a first negative value obtained by subtracting a first reactor period from a second reactor period herein said second reactor period is a reactor period when second set time, shorter than the first set time, has elapsed after said control rod operation stopped, or a second negative value obtained by subtracting a second inverted reactor period from said first inverted reactor period herein said second inverted reactor period is a inverted reactor period when said second set time has elapsed.
